(19) United States
(12) Patent Application Publication
(10) Pub. No.: US 2008/0312891 A1
(43) Pub. Date: Dec. 18, 2008

(54) DESIGN METHOD, DESIGN SUPPORT APPARATUS, AND COMPUTER PRODUCT FOR FEEDBACK CONTROL SYSTEM

(75) Inventors: Tsugito Maruyama, Kawasaki (JP); Takayuki Kawabe, Kawasaki (JP); Shinji Hara, Kanagawa (JP); Keitaro Ohno, Tokyo (JP)

Correspondence Address: GREER, BURNS & CRAIN, 300 S WACKER DR, 25TH FLOOR, CHICAGO, IL, 60606, US

(73) Assignees: FUJITSU LIMITED, Kawasaki-shi (JP); THE UNIVERSITY OF TOKYO, Tokyo (JP)

(21) Appl. No.: 12/127,407

(22) Filed: May 27, 2008

(30) Foreign Application Priority Data
Jun. 14, 2007 (JP) 2007-157986

(51) Int. Cl. G06G 7/48

(52) U.S. Cl. 703/7

(57) ABSTRACT

A control system is designed in which a controlled plant is controlled based on output feedback from the controlled plant. An all-pass filter is modeled that is formed of a synthesis of a notch filter compensating for a resonance mode in the control system and the resonance mode. A design controlled plant including the all-pass filter is determined. A controller controls the design controlled plant and includes a weighting function, and, after the weighting function is derived, gain of the weighting function is adjusted using desired gain crossover frequency and phase margin. A phase variable included in a phase-lead weight is determined, and thus the weighting function is determined. H∞ loop shaping is applied to the weighting function and the design controlled plant to obtain an H∞ loop controller.

### BACKGROUND OF THE INVENTION

1. Field of the Invention

The present invention relates to a design method, a design support apparatus, and a computer product for a feedback control system.

2. Description of the Related Art

Classical control theory is often used to design a feedback control system including a controlled plant and a controller that controls the controlled plant. The classical control theory allows intuitive and easy design. On the other hand, because gain and phase cannot be separately designed, the design requires trial-and-error.

A conventional design method based on H∞ control theory has been proposed as described in, for example, “State-Space Solutions to Standard H2 and H∞ Control Problems”, IEEE Transactions on Automatic Control, Vol. 34, No. 8, 1989. The H∞ control theory is more systematic compared to the classical control theory. With the conventional design method, a controller that ensures stability and robustness of a closed-loop control system can be designed, and an optimal controller that takes disturbances into consideration can be designed. However, in a standard H∞ control design procedure, a weighting function is difficult to set, and design of an actual controller requires considerable experience. Specifically, intuitive design parameters of the classical control theory are difficult to be correlated with parameters of the H∞ control theory. In addition, it is not always clear how minute changes in the weighting function of the H∞ control theory are reflected in a design result of a controller. Therefore, design of a controller based on the H∞ control theory is difficult to be applied to practical use.

To resolve the difficulty in weighting function setting in the H∞ control theory, H∞ loop shaping design procedure has been proposed in, for example, “A Loop Shaping Design Procedure Using H∞ Synthesis”, IEEE Transactions on Automatic Control, Vol. 37, No. 6, 1992, and “Finite Frequency Phase Property Versus Achievable Control Performance in H∞ Loop Shaping Design”, SICE-ICCAS International Joint Conference, 2006. In the Hoc loop shaping design procedure, frequency shaping is performed on an open-loop control system using a weighting function. The H∞ control theory is then applied to the shaped control system. Because the frequency shaping is performed on the open-loop control system, the design is highly compatible with a design based on the classical control theory, and also, correlation with the design parameters of the classical control theory, such as a phase margin, is clear. Therefore, an on-site designer can easily perform tuning during designing.

However, a complex real system cannot always be designed easily based on the H∞ control theory even with the H∞ loop shaping. For example, when a peak (hereinafter, “resonance mode”) of a narrow band is present in a high frequency area of a controlled plant model, correlation between the design parameters of the classical control theory and the parameters of the H∞ control theory, such as gain crossover frequency margin and phase margin, may deviate from a theoretical value. Besides, a designed controller may be of non-minimum phase.

In such a case, the H∞ loop shaping may be applied through compensation for the resonance mode by using a notch filter that rapidly attenuates part of a frequency band as a weighting function. The notch filter can be included in a controlled plant model. However, some filtering by the notch filter is partly cancelled by a designed controller, and desired filtering characteristics may not be achieved. Further, with such a notch filter, the designed controller becomes excessively high-dimensional.

Additionally, in the H∞ loop shaping, the correlation with the design parameters of the classical control theory is clear only in systems such as stable second-order systems and third-order systems of limited class. The correlation is not always clear in the real system. Because the correlation with the intuitive design parameters, such as phase margin, is not clear, it is difficult to manually modify and adjust a controller designed through the H∞ loop shaping and mounted.

Furthermore, narrow-band disturbances in a control loop of the real system are not easy to remove Generally, a resonance filter is used to remove narrow-band disturbances. However, to achieve desired effects through the classical control theory, it is necessary to change characteristics of the resonance filter based on phase conditions and frequency band as well as taking stability into consideration. When the standard H∞ control theory is applied, design can be performed with disturbances being included in a weighting function. However, as described above, the weighting function is difficult to set based on the H∞ control theory. Consequently, considerable trial-and-error is required to achieve desired controller characteristics.

### SUMMARY OF THE INVENTION

It is an object of the present invention to at least partially solve the problems in the conventional technology.

According to an aspect of the present invention, there is provided a design method for a feedback control system in which a controlled plant is controlled based on output feedback from the controlled plant. The design method includes modeling a design controlled plant that includes the controlled plant and a controller that controls the design controlled plant and includes a weighting function; deriving the weighting function included in the controller modeled at the modeling; determining the weighting function derived at the deriving using any one of a desired gain crossover frequency and a desired stability margin; and designing an optimal controller by applying H-infinity control theory to the weighting function determined at the determining and the design controlled plant modeled at the modeling.

According to another aspect of the present invention, there is provided a design support apparatus for a feedback control system in which a controlled plant is controlled based on output feedback from the controlled plant. The design support apparatus includes a modeling unit that performs modeling of a design controlled plant that includes the controlled plant and modeling of a controller that controls the design controlled plant and includes a weighting function; a deriving unit that derives the weighting function included in the controller modeled by the modeling unit; a determining unit that determines the weighting function derived by the deriving unit using any one of a desired gain crossover frequency and a desired stability margin; and a designing unit that designs an optimal controller by applying H-infinity control theory to the weighting function determined by the determining unit and the design controlled plant modeled by the modeling unit.

According to still another aspect of the present invention, there is provided a computer-readable recording medium that stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart of a procedure of control system design performed by a design support apparatus according to an embodiment of the present invention;

FIG. 2 is a Bode diagram of an example of frequency response in a control system;

FIG. 3 is a schematic diagram of an example of a feedback control system according to the embodiment;

FIG. 4 is a schematic diagram for explaining design of the feedback control system;

FIG. 5 is a schematic diagram of a design controlled plant according to the embodiment;

FIG. 6 is a detailed flowchart of a filter design process shown in FIG. 1;

FIG. 7 is a Bode diagram for explaining an example of modeling of an all-pass filter shown in FIG. 6;

FIG. 8 is a schematic diagram of a controller shown in FIG. 3;

FIG. 9 is an example of disturbance frequency characteristics;

FIG. 10 is a Bode diagram of an example of a PI compensation weight according to the embodiment;

FIG. 11 is a Bode diagram of an example of a roll-off compensation weight according to the embodiment;

FIG. 12 is a Bode diagram of an example of a narrow-band disturbance compensation weight according to the embodiment;

FIG. 13 is a Bode diagram of an example of a phase-lead weight according to the embodiment;

FIG. 14 is a detailed flowchart of a gain adjustment process shown in FIG. 1;

FIG. 15 is a detailed flowchart of a phase-lead weight determining process shown in FIG. 1;

FIG. 16 is a Bode diagram of an example of an open-loop frequency characteristics according to the embodiment; and

FIG. 17 is an example of a display screen of the design support apparatus according to the embodiment.

### DETAILED DESCRIPTION OF THE PREFERRED EMBODIMENTS

Exemplary embodiments of the present invention are explained in detail below with reference to the accompanying drawings.

According to an embodiment of the present invention, modeling is performed on a controller including a weighting function based on H∞ control theory. The weighting function is derived from physically meaningful gain crossover frequency or phase margin, and an optimal controller is designed using the weighting function.

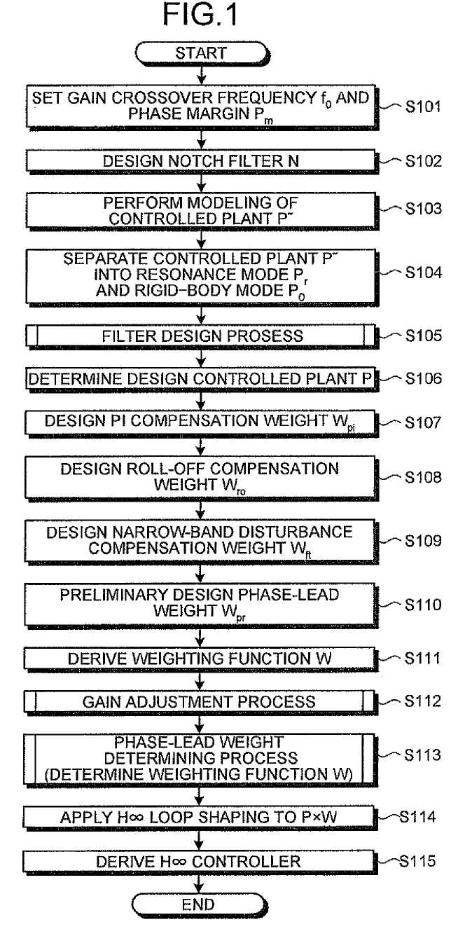

FIG. 1 is a flowchart of a procedure of control system design according to the embodiment. This procedure is broadly divided into four stages: modeling a controlled plant (Steps S101 to S103), determining a design controlled plant (Steps S104 to S106) deriving a weighting function (Steps S107 to S111), and deriving a controller (Steps S112 to S115). The procedure is performed by a design support apparatus or performed by a computer program running on, for example, a personal computer. It is herein assumed that a control system is designed with a design support apparatus.

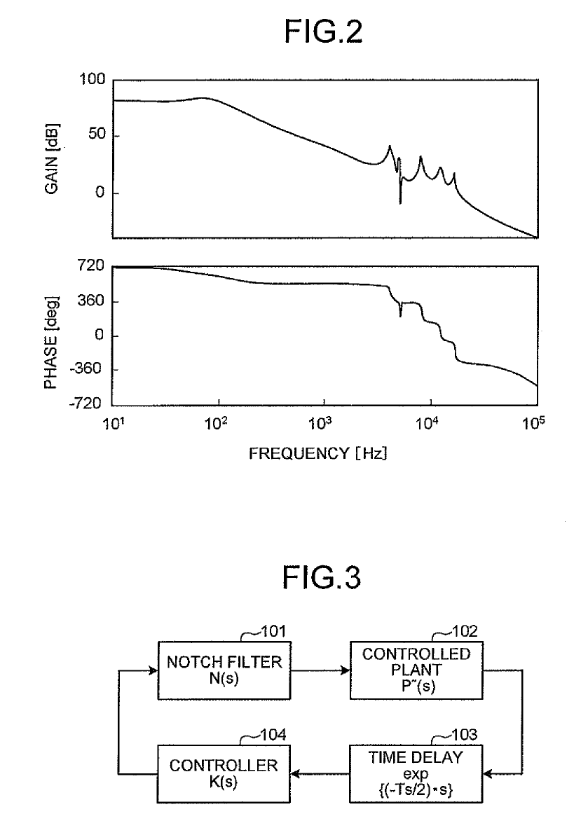

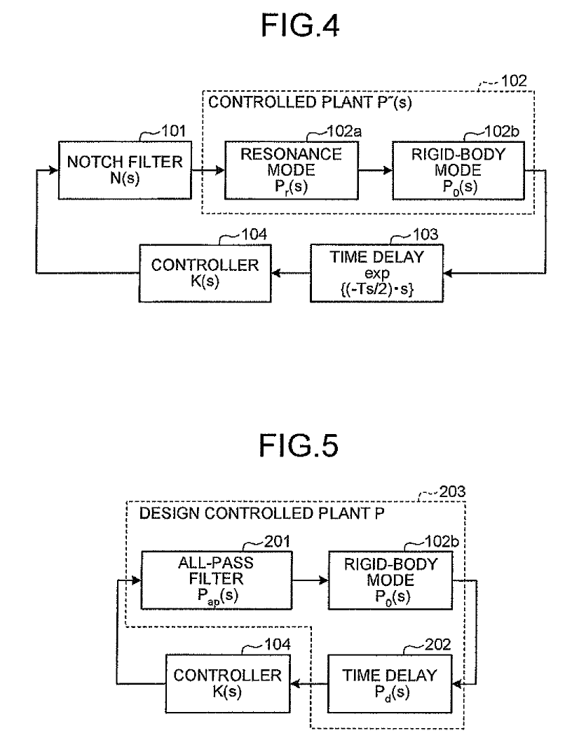

This embodiment describes design of a feedback control system for positioning the head of a magnetic disk device. A controlled plant of the feedback control system is assumed to have frequency characteristics as shown in FIG. 2. Referring to FIG. 2, in the controlled plant, resonance mode often appears around a frequency band of 10 kHz.

Described First is modeling of the controlled plant performed at the first stage. A designer determines desired gain crossover frequency f₀ and phase margin Pₘ required of the feedback control system to be designed, and sets them in the design support apparatus (Step S101). The gain crossover frequency f₀ and the phase margin Pₘ are intuitive design parameters in the classical control theory and are easily determined. It is assumed herein that the gain crossover frequency f₀ is 1500 Hz and the phase margin Pₘ is 30 degrees. After these design parameters are set, modeling of the controlled plant is performed by the design support apparatus.

Specifically, because the resonance mode often appears in the frequency characteristics of the controlled plant, the designer determines to compensate for the resonance mode by a notch filter. Upon receipt of this information, the design support apparatus is provided with a feedback control system configured, for example, as shown in FIG. 3. FIG. 3 is a schematic diagram of the feedback control system. The feedback control system includes a notch filter 101, a controlled plant 102, a time delay 103, and a controller 104.

With the design support apparatus, the notch filter 101 is designed to compensate for the resonance mode (Step S102), and modeling of the controlled plant 102 is performed (Step S103). Incidentally, the controlled plant 102 is not a design controlled plant but an actual controlled plant having the frequency characteristics shown in FIG. 2. The time delay 103 is the one that occurs in feedback from the controlled plant 102 to the controller 104. The time delay 103 is represented by exp{(−Ts/2)·s} using a sampling frequency Ts. In the last result, the controller 104 is designed by the design support apparatus.

Described below is determination of design controlled plant performed at the second stage. After modeling of the feedback control system by the design support apparatus, the controlled plant 102 is separated into a resonance mode 102a and a rigid-body mode 102b (Step S104). Among these modes, the notch filter 101 compensates for the resonance mode 102a. However, filtering by the notch filter 101 is often partially canceled by the controller 104. Therefore, as shown in FIG. 5, the design support apparatus performs a filter design process to synthesizes the notch filter 101 and the resonance mode 102a as well as modeling them as an all-pass filter 201 (Step S105).

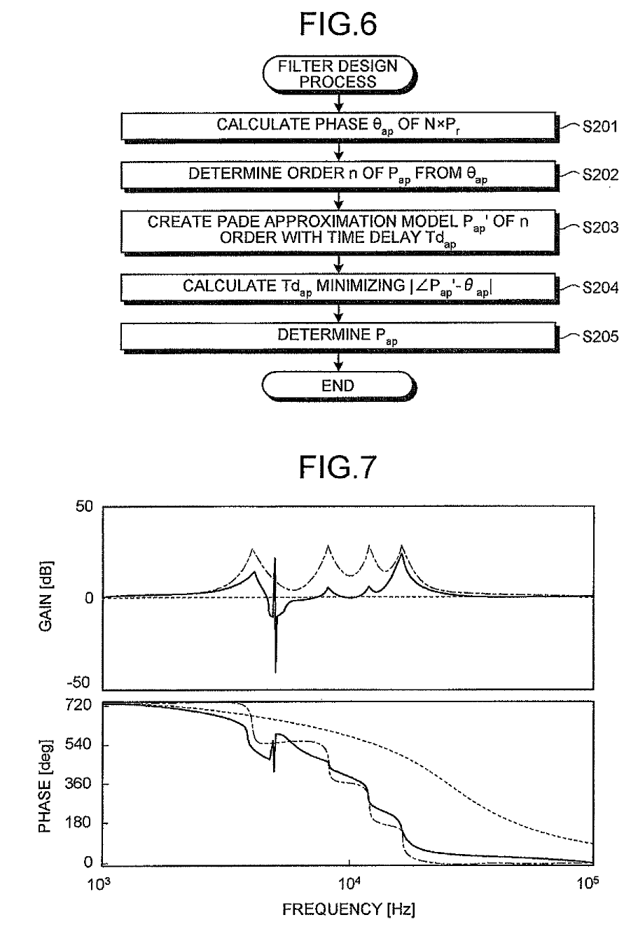

Specifically, as shown in FIG. 6, the design support apparatus calculates a phase θₐₚ of a synthesis of the notch filter 101 and the resonance mode 102a (Step S201). Then, an order n of the all-pass filter 201 is determined from the phase θₐₚ (Step S202). More specifically, the order n of the all-pass filter 201 is determined from the phase θₐₚ at the infinite frequency. When the order n is determined, the design support apparatus creates a model using the Pade approximation (Step S203). That is, an n order model Pₐₚ′ is created with a time delay Tdₐₚ in the all-pass filter 201.

Then, in a range of frequency 0 (zero) to the gain crossover frequency f₀, the time delay Tdₐₚ is calculated that minimizes a phase difference between the model Pₐₚ′ and the phase θₐₚ (Step S204). The time delay Tdₐₚ is applied to the model Pₐₚ′, and the all-pass filter 201 is determined (Step S205). FIG. 7 is a Bode diagram for explaining the modeling of the all-pass filter 201 described above. In FIG. 7, a broken line indicates the rigid-body mode 102b and a solid line indicates the all-pass filter 201. A dashed line indicates the resonance mode 102a compensated by the notch filter 101. It can be seen from FIG. 7 that, in the bands at or below the desired gain crossover frequency f₀ (1500 Hz), the all-pass filter 201 sufficiently approximates the resonance mode 102a compensated by the notch filter 101.

Along with the design of the all-pass filter 201, the time delay 103 is approximated by the Pade approximation to a time delay 202. The all-pass filter 201, the rigid-body mode 102b, and the time delay 202 are determined to as a design controlled plant 203 (Step S106). Since the design controlled plant 203 includes the all-pass filter 201, the design controlled plant 203 is a controlled plant equivalent to the actual controlled plant 102 in which the notch filter 101 compensates for the resonance mode 102a. Although the design controlled plant 203 includes the notch filter 101, the notch filter 101 serves as the all-pass filter 201 during the design of a controller according to the embodiment. Therefore, the filtering by the notch filter 101 is not canceled by the controller 104. Besides, the controller 104 can be prevented from becoming unnecessarily high-dimensional.

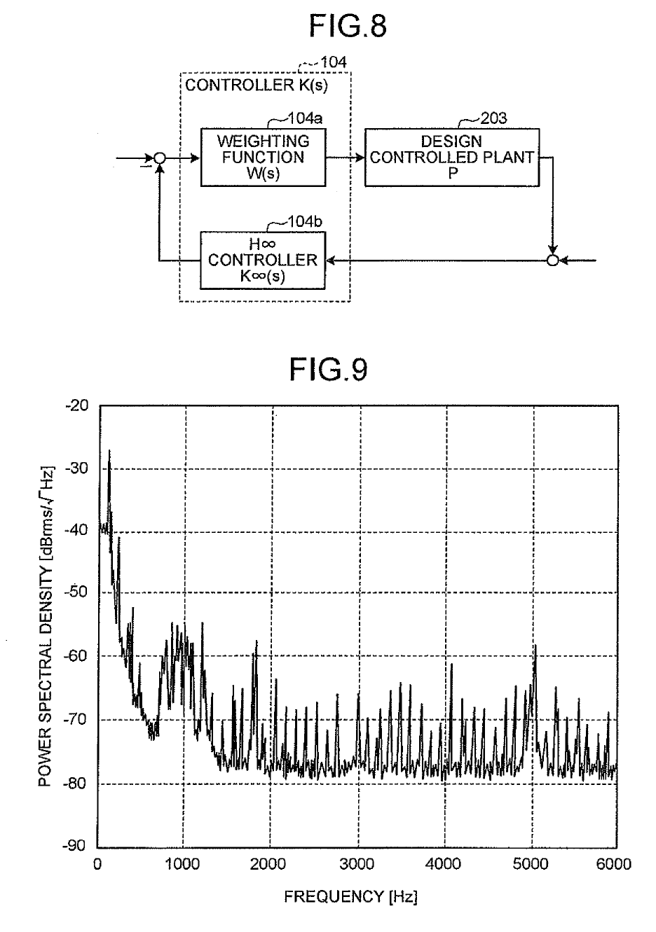

As shown in FIG. 8, the controller 104 including a weighting function 104a and an H∞ controller 104b controls the design controlled plant 203, and the feedback control system is modeled. That is, the design support apparatus performs modeling of the design controlled plant 203 such that the design controlled plant 203 includes the all-pass filter 201 and the rigid-body mode 102b, and modeling of the controller 104 such that the controller 104 includes the weighting function 104a and the H∞ controller 104b. This facilitates modification of the weighting function 104a derived at the third stage, described below, during design and after mounting of the controller 104.

Described next is derivation of the weighting function performed at the third stage. According to the embodiment, the weighting function 104a is a product of a proportional integral (PI) compensation weight Wₚᵢ, a toll-off compensation weight Wᵣₒ, a narrow-band disturbance compensation weight W_{ft}, and a phase-lead weight Wₚᵣ. The design support apparatus designs each weight and derives the weighting function 104a.

Specifically, the design support apparatus designs the PI compensation weight Wₚᵢ that removes disturbances in the low frequency range using Equation (1) as follows (Step S107):

Wₚᵢ(S)=kₚᵢ(1+2πfₚᵢ/s) (1)

where kₚᵢ is gain of the PI compensation weight Wₚᵢ, and fₚᵢ is a break frequency.

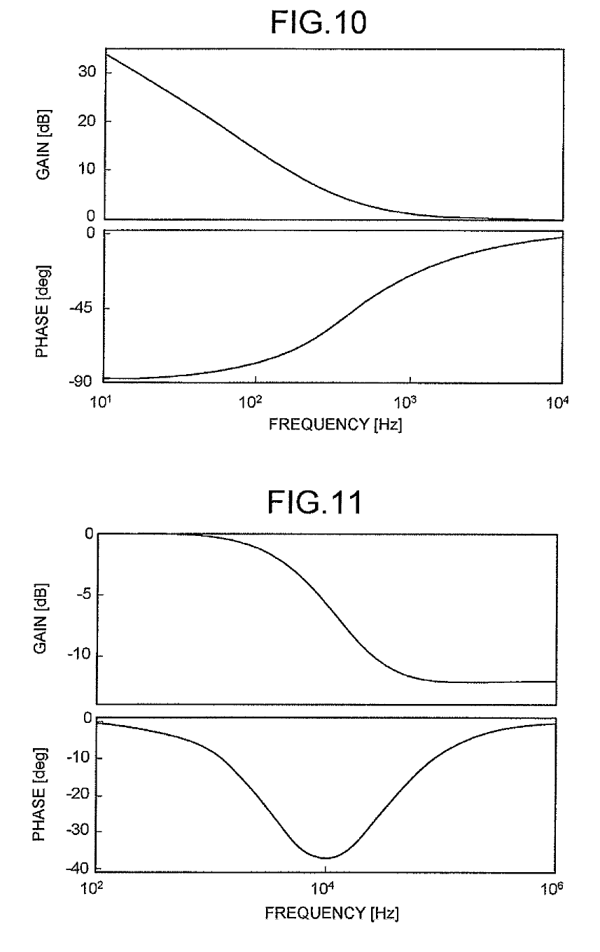

At this time, the design support apparatus sets gain kₚᵢ of the PI compensation weight Wₚᵢ to 1 at the gain crossover frequency f₀. Upon design of the PI compensation weight Wₚᵢ using Equation (1), for example, respective characteristics are determined to approximate disturbance frequency characteristics shown in FIG. 9. With this, the PI compensation weight Wₚᵢ as shown in FIG. 10 is acquired.

After the PI compensation weight Wₚᵢ is designed, the design support apparatus designs the roll-off compensation weight Wᵣₒ that removes modeling errors and disturbances in the high frequency range using Equation (2) as follows (Step S108)

$${W}_{ro} ( s ) = \frac{0.5 π {f}_{high} s + 1}{0.5 π {f}_{low} s + 1} \qquad ( 2 )$$

Upon design of the roll-off compensation weight Wᵣₒ using Equation (2), a lower limit frequency f_{low} and a higher limit frequency f_{high} in Equation (2) are set to lower the gain in a band likely to have a large modeling error. Specifically, for example, when modeling error is likely to be large in frequency bands at 5 kHz or higher, as the frequency characteristics shown in FIG. 2, the lower limit frequency f_{low} and the higher limit frequency f_{high} in Equation (2) are set to lower the gain in the bands. As a result, the roll-off compensation weight Wᵣₒ as shown in FIG. 11 is acquired.

After the roll-off compensation weight Wᵣₒ is designed, the design support apparatus designs the narrow-band disturbance compensation weight W_{ft} that removes narrow-band disturbances using Equation (3) as follows (Step S109):

$${W}_{f t} ( s ) = {\prod }_{i = 1}^{n} \frac{{s}^{2} + 2 {η}_{i} {ω}_{i} s + {ω}_{i}^{2}}{{s}^{2} + 2 {ξ}_{i} {η}_{i} {ω}_{i} s + {ω}_{i}^{2}} \qquad ( 3 )$$

where ξᵢ is a parameter indicating a width of an i-th resonance peak, and ηᵢ is a parameter indicating a height of the i-th resonance peak.

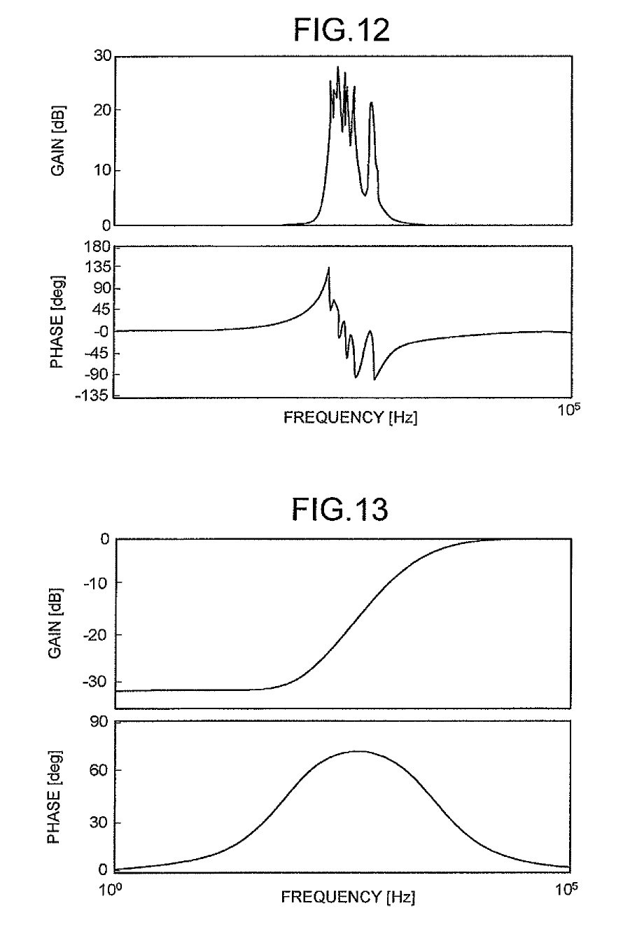

Upon design of the narrow-band disturbance compensation weight W_{ft} using Equation (3) ξᵢ and ηᵢ in Equation (3) are set such that narrow-band disturbances present in a large amount in a certain frequency band are removed. Specifically, for example, in the case of disturbance frequency characteristics as shown in FIG. 9, a large amount of narrow-band disturbances are present near 1000 Hz. Therefore, the parameters in Equation (3) are set to remove these disturbances. As a result, the narrow-band disturbance compensation weight W_{ft} as shown in FIG. 12 is acquired.

After the narrow-band disturbance compensation weight W_{ft} is designed, the design support apparatus preliminary designs the phase-lead weight Wₚᵣ using Equation (4) as follows (Step S110):

$${W}_{pr} ( s ) = k \frac{s + 2 π {f}_{0} ( 1 - ω )}{s + 2 π {f}_{0} ( 1 + ω )} \qquad ( 4 )$$

where k is a gain of the overall weighting function 104a, and ω is a phase variable calculated from the desired phase margin Pₘ (30 degrees).

At this time, the design support apparatus sets the phase-lead weight Wₚᵣ to achieve a desired phase θ at the gain crossover frequency f₀. The desired phase θ can be obtained from the phase margin Pₘ using Equation (5) as follows:

$$θ = \frac{π ln ( {γ}_{t}^{2} - 1 )}{4 ln ( 1 + \sqrt{2} )} - \frac{π}{2} \\ where \\ {γ}_{t} = \frac{1}{sin ( {P}_{m} / 2 )} \qquad ( 5 )$$

The desired phase θ herein is about 225 degrees because the phase margin Pₘ is 30 degrees. The phase-lead weight Wₚᵣ that achieves the desired phase θ is as shown in FIG. 13. The PI compensation weight Wₚᵢ, the roll-off compensation weight Wᵣₒ, the narrow-band disturbance compensation weight W_{ft}, and the phase-lead weight Wₚᵣ obtained as above are multiplied and the weighting function 104a is derived (Step S111).

At this point, the gain k and the phase variable ω in the phase-lead weight Wₚᵣ are not yet definitively determined. The phase-lead weight Wₚᵣ is determined at the fourth stage described below, and the weighting function 104a is determined.

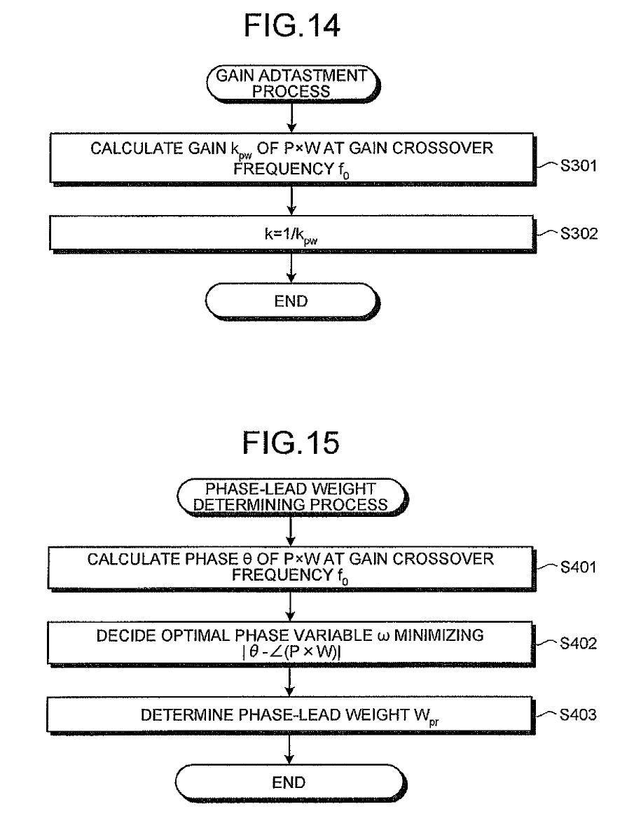

Described next is derivation of a controller performed at the fourth stage. When the design support apparatus derives the weighting function 104a, the gain k of the weighting function 104a in the phase-lead weight Wₚᵣ shown in Equation (4) is adjusted (Step S112). Specifically, as shown in FIG. 14, the design support apparatus calculates gain k_{PW} of a synthesis of the design controlled plant 203 and the weighting function 104a at the gain crossover frequency f₀ (Step S301). The reciprocal of the gain k_{PW} is regarded as the gain k of the weighting function 104a (Step S302). By adjusting the gain k of the weighting function 104a in this manner, a gain crossover frequency of a weighted open-loop system matches the desired gain crossover frequency f₀.

After the gain k in the phase-lead weight Wₚᵣ is adjusted, the phase variable ω in the phase-lead weight Wₚᵣ is determined, and thereby the phase-lead weight Wₚᵣ is determined, As a result, the weighting function 104a is determined (Step S113). Specifically, as shown in FIG. 15, the design support apparatus calculates, using Equation (5), the desired phase θ of the weighted open-loop system including the design controlled plant 203 and the weighting function 104a (Step S401). In other words, the desired phase θ of the weighted open-loop system at the desired gain crossover frequency f₀ is calculated.

When the desired phase θ is calculated, the phase variable ω is determined that minimizes a phase difference between the desired phase θ and the weighted open-loop system at the gain crossover frequency f₀ (Step S402). By substituting the determined phase variable ω for the phase-lead weight Wₚᵣ in Equation (4), the phase-lead weight Wₚᵣ is determined (Step S403). Thus, the weighting function 104a is determined.

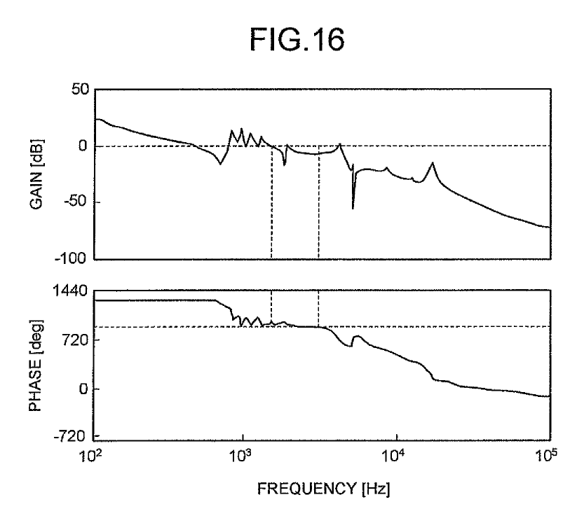

The H∞ loop shaping is applied to the weighting function 104a and the design controlled plant 203 determined as above (Step S114), and the H∞ loop controller 104b is derived (Step S115). As a result, the frequency characteristics of the open-loop system are as shown in FIG. 16. In the frequency characteristics, gain crossover frequency is 1460 Hz and phase margin is 31.7 degrees. These values are close to the desired gain crossover frequency f₀ of 1500 Hz and the phase margin Pₘ of 30 degrees.

It can be seen from FIG. 16 that narrow-band disturbances around 1000 Hz are sufficiently compensated. In general magnetic disk devices, narrow-band disturbances are likely to occur around 1000 Hz due to disk fluttering and the like. Besides, the band is close to the upper limit of the control band, and its frequency is very close to the open-loop gain crossover frequency. Therefore, it is difficult to design a filter that stably compensates for narrow-band disturbances. On the other hand, according to the embodiment, narrow-band disturbances around the 1000 Hz can be easily reduced without trial-and-error.

As described above, according to the embodiment, modeling is performed on a design controlled plant including an all-pass filter formed of a resonance mode and a notch filter, and on a controller including a weighting function and a H∞ loop controller. The phase-lead weight is preliminary designed using a phase variable to derive a weighting function. The gain of an overall weighting function and a phase-lead weight are adjusted from design parameters for a weighted controlled plant. Therefore, the design parameters can be intuitive as, for example, a gain crossover frequency and a phase margin used in the classic control theory. Also, systematic design can be performed based on the H∞ control theory, and a stable and robust real system can be efficiently designed. In addition, a filter based on the classic control theory is included in the controller as the weighting function, redesign, when required, can be handled on-site without using the H∞ control theory.

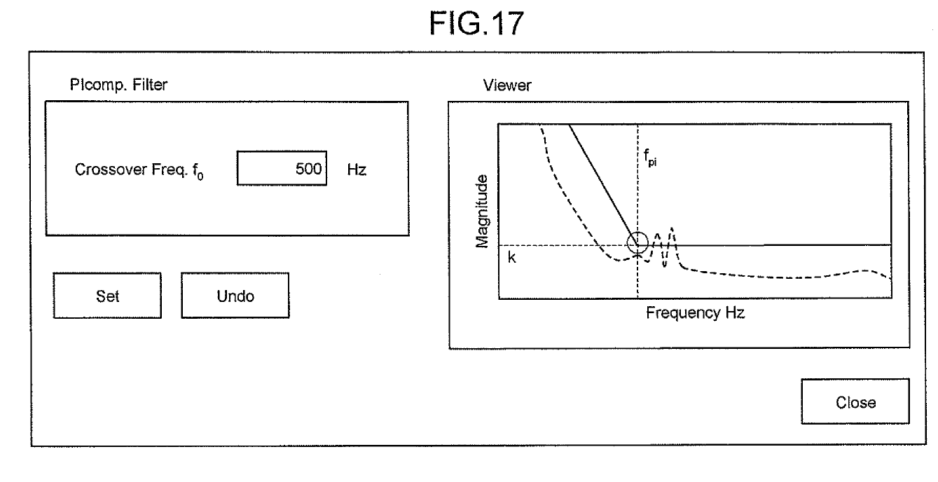

The design support apparatus can be provided with a graphical user interface (GUI). In this case, the designer can visually set parameters, for example, through a display screen as shown in FIG. 17. In the example of FIG. 17, the designer can set the break frequency fₚᵢ and the gain k by, for example, dragging with a mouse to match the shapes of the frequency characteristics of the PI compensation weight Wₚᵢ (indicated by the solid line in the right-hand frame in FIG. 17) with the disturbance frequency characteristics (indicated by the broken line in the right-hand frame in FIG. 17). In other words, the designer can easily set the frequency characteristics of the PI compensation weight Wₚᵢ to approximate the disturbance frequency characteristics. Parameters can be set in the same manner for the roll-off compensation weight Wᵣₒ, the narrow-band disturbance compensation weight W_{ft}, and the phase-lead weight Wₚᵣ. Thus, the designer can intuitively set a weighting function.

As set forth hereinabove, according to an embodiment of the present invention, a weighting function can be set by using intuitive design parameters as used in the classical control theory. Also, systematic design can be performed based on the H∞ control theory, and a stable and robust real system can be efficiently designed.

Moreover, a notch filter is not required to compensate for a resonance mode, and thus filtering by such a notch filter is not cancelled by an optimal controller. As a result, the resonance mode can be reliably compensated. After the optimal controller is designed, a weighting function included in the controller can be easily redesigned.

Furthermore, a weighting function can be derived that is capable of removing disturbances and modeling errors in various frequency bands. As a result, the optimal controller can reliably compensate for the disturbances. Besides, desired parameters based on the classical control theory can be easily achieved. In addition, robustness can be ensured that compensates for disturbances in all frequency bands.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A design method for a feedback control system in which a controlled plant is controlled based on output feedback from the controlled plant, the design method comprising:
modeling a design controlled plant that includes the controlled plant and a controller that controls the design controlled plant and includes a weighting function;
deriving the weighting function included in the controller modeled at the modeling;
determining the weighting function derived at the deriving using any one of a desired gain crossover frequency and a desired stability margin; and
designing an optimal controller by applying H-infinity control theory to the weighting function determined at the determining and the design controlled plant modeled at the modeling.

2. The design method according to claim 1, wherein
the modeling includes
dividing the controlled plant into a resonance mode and a rigid-body mode; and
filter-modeling the resonance mode and an all-pass filter as a substitute for a filter that compensates for the resonance mode, and
the design controlled plant modeled at the modeling includes the rigid-body mode and the all-pass filter obtained at the filter-modeling.

3. The design method according to claim 1, wherein the modeling includes modeling the controller by the weighting function and an H-infinity loop controller.

4. The design method according to claim 1, wherein the weighting function derived at the deriving includes at least one of a proportional integral compensation weight, a roll-off compensation weight, a narrow-band disturbance compensation weight, and a phase-lead weight.

5. The design method according to claim 1, wherein the determining includes adjusting gain of the weighting function such that a gain crossover frequency of a system in which the design controlled plant is synthesized with the weighting function matches the desired gain crossover frequency.

6. The design method according to claim 1, wherein
the determining includes determining a phase-lead weight that minimizes a phase difference between a phase of a system in which the design controlled plant is synthesized with the weighting function and a desired phase calculated from the desired stability margin, and
the weighting function determined at the determining includes the phase-lead weight.

7. The design method according to claim 1, wherein the weighting function derived at the deriving includes a frequency characteristic that approximates a disturbance frequency characteristic.

8. A computer-readable recording medium that stores therein a computer program for design of a feedback control system in which a controlled plant is controlled based on output feedback from the controlled plant, the computer program causing a computer to execute:
modeling a design controlled plant that includes the controlled plant and a controller that controls the design controlled plant and includes a weighting function;
deriving the weighting function included in the controller modeled at the modeling;
determining the weighting function derived at the deriving using any one of a desired gain crossover frequency and a desired stability margin; and
designing an optimal controller by applying H-infinity control theory to the weighting function determined at the determining and the design controlled plant modeled at the modeling.

9. A design support apparatus for a feedback control system in which a controlled plant is controlled based on output feedback from the controlled plant, the design support apparatus comprising:
a modeling unit that performs modeling of a design controlled plant that includes the controlled plant and modeling of a controller that controls the design controlled plant and includes a weighting function;
a deriving unit that derives the weighting function included in the controller modeled by the modeling unit;
a determining unit that determines the weighting function derived by the deriving unit using any one of a desired gain crossover frequency and a desired stability margin; and
a designing unit that designs an optimal controller by applying H-infinity control theory to the weighting function determined by the determining unit and the design controlled plant modeled by the modeling unit.
